(19) United States
(12) Patent Application Publication
(10) Pub. No.: US 2010/0007407 A1
(43) Pub. Date: Jan. 14, 2010

(54) CIRCUIT FOR GENERATING A NEGATIVE VOLTAGE SUPPLY SIGNAL, AND ASSOCIATED POWER SUPPLY DEVICE AND PORTABLE ELECTRONIC APPARATUS

(75) Inventors: Kiril TRAJKOVSKI, Malmo (SE); Kaj ULLEN, Bjarred (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/169,128

(22) Filed: Jul. 8, 2008

(51) Int. Cl. G05F 3/02

(52) U.S. Cl. 327/536

(57) ABSTRACT

A circuit for generating a negative voltage supply signal is disclosed. The circuit has a first capacitive element coupled to receive a switched input signal which switches at least between a first state with a positive first voltage and a second state with a second voltage, different from the first voltage. A second capacitive element is coupled to provide the negative voltage supply signal. Control circuitry is coupled to the first capacitive element and the second capacitive element. The control circuitry is arranged, in the first state of the switched input signal, to enable charging of the first capacitive element by the switched input signal, and, in the second state of the switched input signal, to enable charging of the second capacitive element by the first capacitive element to generate the negative voltage supply signal.

### TECHNICAL FIELD

The present invention relates to a circuit for generating a negative voltage supply signal. In particular, the invention relates to an inexpensive provision of negative voltage supply for use in or with an associated power supply device and/or an associated portable electronic apparatus.

### BACKGROUND

Electrical power supply devices for portable electronic apparatuses are in common use. Mobile terminals, such as mobile telephones and personal digital assistants (PDAs) for mobile telecommunications systems like GSM, UMTS, D-AMPS, CDMA2000, FOMA or TD-SCDMA, are common examples of portable electronic apparatuses. A mobile terminal will therefore be used as a non-limiting example of a portable electronic apparatus in the remainder of this specification.

A mobile terminal is normally driven by positive supply voltages. Recent requirements from e.g. audio and illumination developments have however made it preferable or even mandatory to use a negative voltage supply in addition to the normal positive voltage supply. As for most mass-produced products, it is important to keep the components involved as few and simple as possible, to save space and costs. In other words, a problem can be seen in how to provide such a negative voltage supply for a portable electronic apparatus like a mobile terminal, which conventionally only has a positive voltage supply.

### SUMMARY

Generally, the present invention is based on the understanding that beneficial use can be made of an switched positive-voltage input signal, which is available in the portable electronic apparatus for other reasons, to generate a negative voltage supply signal.

A first aspect of the present invention is therefore a circuit for generating a negative voltage supply signal. The circuit comprises a first capacitive element coupled to receive a switched input signal which switches at least between a first state with a positive first voltage and a second state with a second voltage, that is different from the first voltage and typically is substantially zero. The circuit also comprises a second capacitive element coupled to provide said negative voltage supply signal, and control circuitry coupled to the first capacitive element and the second capacitive element. The control circuitry is arranged, in the first state of the switched input signal, to enable charging of the first capacitive element by the switched input signal, and, in the second state of the switched input signal, to enable charging of the second capacitive element by the first capacitive element to generate the negative voltage supply signal.

This represents a simple and inexpensive solution to the aforementioned problem. Beneficial use is made of a switched input signal which, as will be explained in more detail later, may serve another purpose as well in the portable electronic apparatus and therefore may already be available.

In one or more embodiments, the control circuitry comprises a first rectifying element, such as a diode, which is forward-biased in the first state of the switched input signal and reverse-biased in the second state of the switched input signal; and a second rectifying element, such as a diode, which is reverse-biased in the first state of the switched input signal and forward-biased in the second state of the switched input signal.

In one or more embodiments, the first capacitive element is a capacitor having a first end coupled to receive the switched input signal and a second end coupled to a first end of the first rectifying element. The second capacitive element is also a capacitor having a first end coupled to a second end of the first rectifying element and a second end coupled to provide the negative voltage supply signal. Furthermore, the second rectifying element has a first end coupled to the second end of the second capacitive element and a second end coupled to the second end of the first capacitive element.

A node between the first end of the second capacitive element and the second end of the first rectifying element may be grounded.

A second aspect of the present invention is a power supply device for an electronic apparatus. The power supply device comprises a switched signal source to generate a switched input signal which switches at least between a first state with a positive first voltage and a second state with a second voltage, different from the first voltage. The power supply device also comprises a positive voltage supply generator to generate a positive voltage supply signal, and a circuit for generating a negative voltage supply signal according to the first aspect of the present invention.

Advantageously, the switched signal source is included in the positive voltage supply generator. By using an already existing positive voltage supply generator as the switched signal source, an efficient implementation can be done for the negative voltage supply signal generating circuit. In one or more embodiments, the positive voltage supply generator is thus a switching regulator, such as a step-up regulator, which includes an inductor, an electronic switch having an on-state and an off-state, a capacitor, and a controller. The controller is configured to cause the electronic switch to alternate between its on-state, during which electric energy is integrated in the inductor, and its off-state, during which the capacitor is charged from electric energy integrated in the inductor and the positive voltage supply signal is provided at one end of the capacitor. Advantageously, a node between the inductor and the electronic switch in the switching positive voltage supply generator is used as the switched signal source for the negative voltage supply signal generating circuit.

Alternatively, the switched signal source may instead be derived from another device. Therefore, in an alternative embodiment, the switched signal source is a clock terminal or other pulsed-signal terminal of a digital logic circuit, such as a microcontroller, central processing unit (CPU), digital signal processor (DSP), etc.

A third aspect of the present invention is a portable electronic apparatus having at least one electric device configured to be supplied with a positive voltage supply signal and a negative voltage supply signal. The portable electronic apparatus also has a circuit for generating the negative voltage supply signal in accordance with the first aspect of the present invention. The portable electronic apparatus may advantageously be a mobile terminal such as a mobile telephone or a personal digital assistant (PDA) for a mobile telecommunications system like GSM, UMTS, D-AMPS, CDMA2000, FOMA or TD-SCDMA.

### BRIEF DESCRIPTION OF DRAWINGS

Objects, features and advantages of embodiments of the invention will appear from the following detailed description, reference being made to the accompanying drawings.

FIGS. 1 and 2 are schematic front and rear views, respectively, of a portable electronic apparatus according to an embodiment of the present invention, embodied as a mobile terminal.

FIG. 3 illustrates one exemplifying situation where a negative voltage supply is required in a mobile terminal.

FIG. 4 is a schematic block diagram which serves to illustrate an embodiment of the invention on a conceptual level, with a circuit for generating a negative voltage supply signal and a power supply device in a portable electronic apparatus.

FIG. 5 is a circuit diagram of a circuit for generating a negative voltage supply signal in association with a step-up regulator, constituting a power supply device according to one embodiment of the invention.

FIG. 6 is a schematic graph which demonstrates voltage vs time characteristics of a switched input signal used in the embodiment of FIG. 5.

### DETAILED DESCRIPTION

An embodiment of the invention will be now described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like elements are represented by like reference numerals.

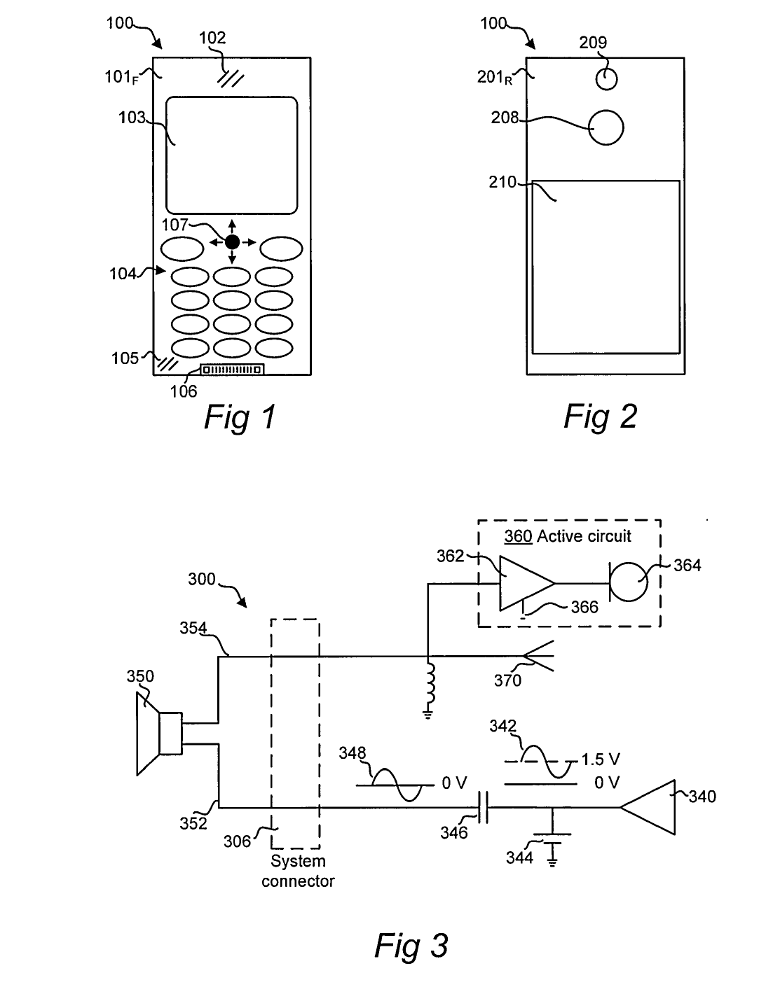

FIGS. 1 and 2 show a portable electronic apparatus in the form of a mobile terminal 100. The mobile terminal 100 has a housing that includes a front side 101_{F} and a rear side 201_{R}. The front side 101_{F} has a user interface that includes a speaker 102, a microphone 105, a display 103, and a set of keys 104 which may include an ITU-T type keypad (i.e., an alpha-numerical keypad representing keys 0-9, * and #) as well as special keys like soft keys. A joystick 107 or similar navigational input device (e.g. scroll keys, touchpad, or navigation key) is also provided. A system connector 106 forms an accessory interface to external devices, such as battery charger or hands-free unit.

The rear side 201_{R} has a camera 208 and an illuminating light emitting diode (LED) 209. A battery case 210 is also provided at the rear side 201_{R}.

Other external components may be provided, such as power switch, battery, volume controls and external antenna, but are not indicated in FIGS. 1 and 2 for the sake of brevity.

In addition to the external components referred to above, the mobile terminal 100 has various internal components, as is readily realized by those skilled in the art. Such internal components may include one or more central processing units (CPU), digital signal processors (DSP), display controllers, memories, various software and firmware—including a real-time operating system, device drivers and application programs—and electronic radio circuitry for establishing and maintaining a wireless link to a base station in an available mobile telecommunications system. As is well known per se, the electronic radio circuitry will typically comprise analog and digital components constituting a radio receiver and transmitter. Such components may include band pass filters, amplifiers, mixers, local oscillators, low pass filters, AD/DA converters, etc. The radio interface typically also includes associated communication service software in the form of modules, protocol stacks and drivers. Typically, the mobile terminal 100 will also include one or more interfaces for short-range supplemental data communication, such as a Bluetooth interface, an IrDA (infrared) interface or a wireless LAN (WLAN) interface.

FIG. 3 illustrates a situation where a negative voltage supply is required in the mobile terminal 100. A speaker 350 is driven by an input audio signal 340 having some DC level, such as 1.5 V, as is illustrated schematically at 342-344. Since a DC level may damage the speaker 350, a blocking capacitor 346 is provided to remove the DC level, as is seen schematically at 348. In the situation shown in FIG. 3, the speaker 350 is part of a portable hands-free (PHF) accessory kit, and therefore the audio signal crosses the system connector 306 in a pair of leads in the form of a feed line 352 and a return line 354.

The PHF accessory kit also serves as an FM antenna 370, which is connected to the return line 354. In addition, an active circuit 360, also part of the PHF accessory kit, is connected to the return line 354. The active circuit includes an amplifier 362 and a microphone 364 and needs to be supplied with a negative supply voltage, as seen at 366.

Various other situations may occur where a negative voltage supply is required in the mobile terminal 100. For instance, certain illumination components may require such a negative voltage supply.

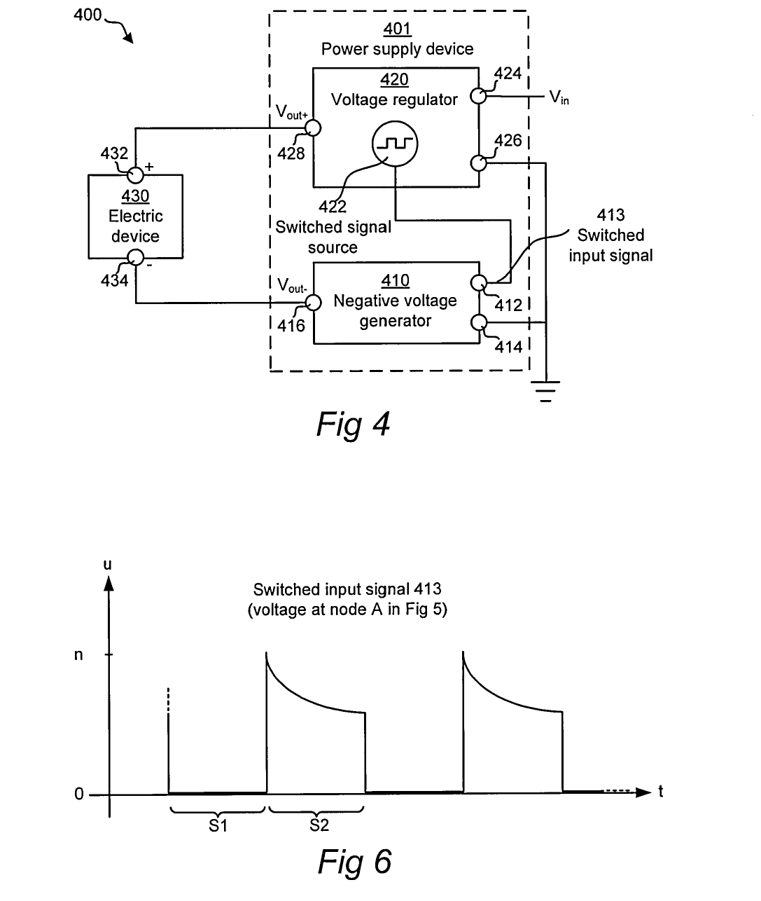

Reference is now made to FIG. 4 which schematically illustrates a portable electronic apparatus, for instance the mobile terminal 100, having an electric device 430 which needs positive as well as negative supply voltages, as seen at 432 and 434. When the portable electronic apparatus 400 is a mobile terminal like mobile terminal 100, the electric device 430 may for instance be the active circuit 360 of FIG. 3.

In FIG. 4, a power supply device 401 is coupled to supply the electric device 430 with positive and negative supply voltages Vₒᵤₜ₊ and Vₒᵤₜ₋ via output supply terminals 428 and 416, respectively. The power supply device 401 includes a voltage regulator 420 having input terminals 424, 426 for receiving a positive input DC voltage Vᵢₙ (for instance from a battery) and for electric ground, respectively. The voltage regulator 420 generates at its output supply terminal 428 a positive voltage supply signal with a more or less constant positive DC level Vₒᵤₜ₊.

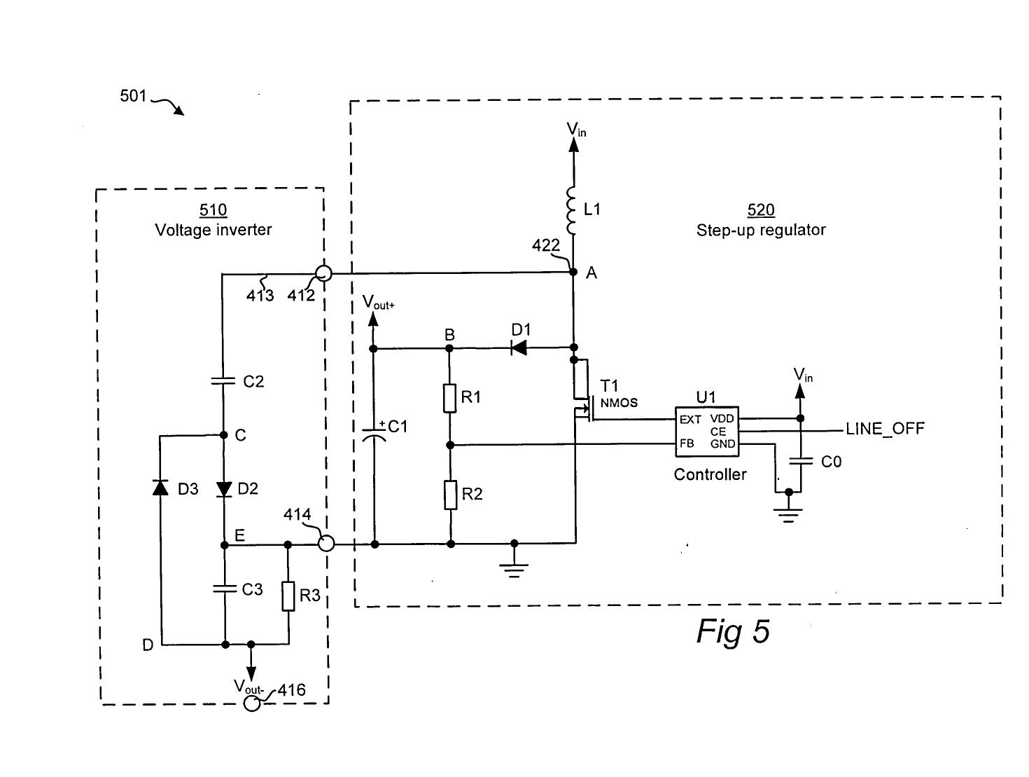

In addition, the power supply device 401 of FIG. 4 includes a negative voltage generator 410 in the form of a circuit for generating a negative voltage supply signal Vₒᵤₜ₋ at the output supply terminal 416. The negative voltage generator 410 is grounded at input terminal 414, like the voltage regulator 420. Unlike the voltage regulator 420, however, the negative voltage generator 410 does not receive the positive input DC voltage Vᵢₙ at the other input terminal 412. Instead, the negative voltage generator 410 receives at its input terminal 412 a switched input signal 413 from a switched signal source 422. As is seen in FIG. 4, the switched signal source 422 may be included in the voltage generator 420, or it may alternatively be derived from a different device, such as a clock terminal or other pulsed-signal terminal of a digital logic circuit like a processor. With reference to FIGS. 5 and 6, the particulars about the switched signal source 422 and the switched input signal 413 that it provides to the negative voltage generator 410 (the circuit for generating a negative voltage supply signal) will be described in more detail with reference to one advantageous embodiment, where indeed the switched signal source 422 is included in the voltage generator 420. First, however, it should be noticed that, of course, if any of the positive and negative supply voltages Vₒᵤₜ₊ and Vₒᵤₜ₋ are too high for the electric device 430, appropriate adaptor circuitry may be provided in the power supply device 401, the electric device 430, or between these devices, to adjust the supply voltages to a suitable level, for instance by voltage division.

FIG. 5 illustrates a power supply device 501 according to aforesaid one advantageous embodiment, including a step-up regulator 520 which may correspond to voltage regulator 420 of FIG. 4, as well as a negative voltage generator 510 (circuit for generating a negative voltage supply signal) which may correspond to negative voltage generator 410 of FIG. 4.

The step-up regulator 520 is configured to receive a positive input DC voltage Vᵢₙ and raise it to a higher voltage level Vₒᵤₜ₊ under control by a controller U1. Such higher voltage level may for instance be needed by one or more white LEDs in the portable electronic apparatus—for instance the illuminating LED 209 in the mobile terminal 100 of FIG. 2. As will soon be described, this embodiment makes beneficial use of the presence of the step-up regulator 520 so as to generate also a negative voltage supply signal Vₒᵤₜ₋ by means of the negative voltage generator 510. In alternative embodiments, the regulator 520 may for instance be replaced by a charge pump.

The operation of the circuitry in FIG. 5 is as follows. The controller U1 is configured to control, via a terminal EXT, an electronic switch in the form of an NMOS transistor T1 to alternate between an on-state (closed) and off-state (open). To this end, the controller U1 receives the positive input DC voltage Vᵢₙ at a terminal VDD as well as a voltage over a capacitor C1, as divided by voltage divider R1 and R2 and representing the desired positive supply voltage Vₒᵤₜ₊.

When T1 is turned on and saturates, a current starts to integrate in an inductor L1. When T1 is then turned off, the voltage at node A (422) goes high, and a diode D1 is forward-biased, thereby allowing the electric energy stored in the inductor L1 to be fed as a current to the capacitor C1. As previously mentioned, the voltage over capacitor C1 is sensed by the controller U1 via resistors R1 and R2, allowing U1 to stabilize Vₒᵤₜ₊ by controlling the switching of T1 between on-state and off-state. During the off-state of T1, when the capacitor C1 is charged by the positive voltage at node A, beneficial use is made of this positive voltage at node A as a switched input signal 413 to be received at terminal 412 of the negative voltage generator 510. The off-state of T1 is referred to as S2 in the graph shown in FIG. 6, from which it can be seen how the switched input signal 413 starts at a positive voltage of n V and decays to a lower but still quite positive voltage at the end of off-state S2.

During T1's off-state S2, a first capacitor C2 in the negative voltage generator 510 is thus charged simultaneously with the capacitor C1 by the switched input signal 413, i.e. the positive voltage at node A is applied to one end of the first capacitor C2, a second of which is connected to ground via a forward-biased first diode D2 (node E in FIG. 5). A reverse-biased second diode D3 prevents at this stage charging of a second capacitor C3 in the negative voltage generator 510. At the end of state S2, the voltage over the capacitor C2 in the negative voltage generator 510 may be for instance about 10 V.

Then, when T1 is switched again to its on-state S1, the switched input signal 413 will drop to zero voltage (as seen in FIG. 6), since node A will be connected to ground via the conducting T1. Thus, the diode D1 in the step-up regulator 520 as well as the first diode D2 in the negative voltage generator 510 will both be reverse-biased, and no current will flow through them. As a consequence, the voltage at node C in FIG. 5, i.e. between the first capacitor C2 and the first and second diodes D2, D3 in the negative voltage generator 510, will be about −10 V. Thus, D2 will now be reverse-biased whereas D3 will be forward-biased. Current will be drawn from the second end of the first capacitor C2 through the second diode D3 and start to charge the second capacitor C3. Thus, a negative voltage Vₒᵤₜ₋ will be built up over C3. In the disclosed embodiment, C2 and C3 are of equal size; therefore the negative voltage Vₒᵤₜ₋ over C3 will be −10 V−[voltage drop over D3], e.g. −10 V−(−0.4 V)=−9.6 V when D3 is a Schottky diode.

Resistor R3 is a small load to allow Vₒᵤₜ₋ to act as aforementioned negative voltage supply signal at the negative supply terminal 416 of the negative voltage generator 510.

The negative voltage generator 510 is therefore, in summary, a circuit for generating a negative voltage supply signal from a switched input signal at node A by converting and transferring voltage from the first capacitor C2 to the second capacitor C3 via a control circuitry in the form of the first and second diodes D2, D3.

In the disclosed embodiment, the component values in the circuitry of FIG. 5 may be as follows:

C0: 100 nF

C1: 4.7 μF

C2: 1 μF

C3: 1 μF

D1: Schottky diode

D2: Schottky diode

D3: Schottky diode

L1: 4.7 μH

R1: 100 kΩ

R2: 10 kΩ

R3: 100 kΩ

The invention has been described above in detail with reference to an embodiment thereof. However, as is readily understood by those skilled in the art, other embodiments are equally possible within the scope of the present invention, as defined by the appended claims.

1. A circuit for generating a negative voltage supply signal, the circuit comprising:
a first capacitive element coupled to receive a switched input signal which switches at least between a first state with a positive first voltage and a second state with a second voltage, different from the first voltage;
a second capacitive element coupled to provide said negative voltage supply signal; and
control circuitry coupled to said first capacitive element and said second capacitive element, said control circuitry being arranged, in said first state of the switched input signal, to enable charging of said first capacitive element by said switched input signal, and, in said second state of the switched input signal, to enable charging of said second capacitive element by said first capacitive element to generate said negative voltage supply signal.

2. The circuit according to claim 1, wherein said control circuitry comprises
a first rectifying element which is forward-biased in said first state of the switched input signal and reverse-biased in said second state of the switched input signal; and
a second rectifying element which is reverse-biased in said first state of the switched input signal and forward-biased in said second state of the switched input signal.

3. The circuit according to claim 2, wherein
said first capacitive element has a first end coupled to receive said switched input signal and a second end coupled to a first end of said first rectifying element;
said second capacitive element has a first end coupled to a second end of said first rectifying element and a second end coupled to provide said negative voltage supply signal; and
said second rectifying element has a first end coupled to the second end of said second capacitive element and a second end coupled to the second end of said first capacitive element.

4. The circuit according to claim 3, wherein a node between the first end of said second capacitive element and the second end of said first rectifying element is grounded.

5. The circuit according to claim 3, wherein said first and second capacitive elements are capacitors.

6. The circuit according to claim 3, wherein said first and second rectifying elements are diodes.

7. The circuit according to claim 1, wherein said second voltage in the second state of said switched input signal is substantially zero.

8. A power supply device for an electronic apparatus, the power supply device comprising
a switched signal source to generate a switched input signal which switches at least between a first state with a positive first voltage and a second state with a second voltage, different from the first voltage;
a positive voltage supply generator to generate a positive voltage supply signal; and
a circuit for generating a negative voltage supply signal, the circuit comprising:
a first capacitive element coupled to receive said switched input signal from said switched signal source;
a second capacitive element coupled to provide said negative voltage supply signal; and
control circuitry coupled to said first capacitive element and said second capacitive element, said control circuitry being arranged, in said first state of the switched input signal, to enable charging of said first capacitive element by said switched input signal, and, in said second state of the switched input signal, to enable charging of said second capacitive element by said first capacitive element to generate said negative voltage supply signal.

9. The power supply device according to claim 8, wherein said switched signal source is included in said positive voltage supply generator.

10. The power supply device according to claim 9, wherein said positive voltage supply generator is a switching regulator which includes
an inductor;
an electronic switch having an on-state and an off-state;
a capacitor; and
a controller, the controller being configured to cause said electronic switch to alternate between its on-state, during which electric energy is integrated in said inductor, and its off-state, during which said capacitor is charged from electric energy integrated in the inductor and said positive voltage supply signal is provided at one end of said capacitor.

11. The power supply device according to claim 10, wherein said switched signal source is a node between said inductor and said electronic switch.

12. The power supply device according to claim 8, wherein said switched signal source is a terminal of a digital logic circuit.

13. A portable electronic apparatus having
at least one electric device configured to be supplied with a positive voltage supply signal and a negative voltage supply signal; and
a circuit for generating said negative voltage supply signal, the circuit comprising:
a first capacitive element coupled to receive a switched input signal from a switched signal source, said switched input signal switching at least between a first state with a positive first voltage and a second state with a second voltage, different from the first voltage;
a second capacitive element coupled to provide said negative voltage supply signal; and
control circuitry coupled to said first capacitive element and said second capacitive element, said control circuitry being arranged, in said first state of the switched input signal, to enable charging of said first capacitive element by said switched input signal, and, in said second state of the switched input signal, to enable charging of said second capacitive element by said first capacitive element to generate said negative voltage supply signal.

14. The portable electronic apparatus according to claim 13, wherein the apparatus is a mobile terminal.
